(19) United States
(12) Patent Application Publication
(10) Pub. No.: US 2024/0099512 A1
(43) Pub. Date: Mar. 28, 2024

(54) Pizza Oven Insert For A Grill

(71) Applicant: Joseph Michael Phillips

(72) Inventor: Joseph Michael Phillips

(21) Appl. No.: 17/954,123

(22) Filed: Sep. 27, 2022

(51) Int. Cl. A47J 37/07; A47J 37/06

(52) U.S. Cl. CPC A47J 37/0786; A47J 37/0658

(57) ABSTRACT

An oven insert for use with a grill or cooker that provides even heat around the top and across the bottom of a cooking plate. Hot air is swirled within a hood creating a convective cooking environment above the cooking plate and heat also flows across the bottom of the cooking plate producing two-sided cooking simultaneously at temperatures ranging from 3000 to 1200°. Heat flows directly into one side of the oven and is distributed across the bottom of a heat distribution plate using a series of openings formed therein to heat the bottom of the cooking plate, and preferably through progressively sized small to large holes arranged in a pattern moving away from the heat source.

### CROSS-REFERENCE TO RELATED PATENTS

The present invention is related to the following U.S. Pat. Nos. 9,186,020 and 9,585,518, each of which is commonly owned along with the present application, the entire contents of each of these two patents being hereby incorporated in their entirety herein by reference thereto:

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This disclosure relates to the cooking generally, and to insert devices for use with cookers, such as pellet fed units, or grills in particular.

### INTRODUCTION

Outdoor cooking, and heated grills of various types, have existed for many years and are widely used. The present invention is directed to a special insert device in the form of a hooded oven that can be placed inside such a grill or cooker and be used for a variety of cooking purposes that will benefit from the specifically designed structure of this particular insert.

### DESCRIPTION OF PRESENTLY PREFERRED EXAMPLES OF THE INVENTION

### Brief Description of Figures

The invention is better understood by reading the following detailed description with reference to the accompanying drawings in which:

FIG. 1 is an elevational view of a cooker or grill the lid of which is open and the insert oven is shown within the grill's cooking chamber;

FIG. 2 is an exploded elevational view of the insert oven;

FIG. 3 is an exploded perspective view of the present insert oven;

FIG. 4 is a top plan view of the present oven.

FIG. 5 is a cross sectional view taken along line A-A in FIG. 4;

FIG. 6 is a front elevational view of the present oven;

FIG. 7 is a cross sectional view taken along line B-B in FIG. 6;

FIG. 8 is a partial cross sectional view of the present oven showing heat flow paths;

FIG. 9 is a bottom perspective view showing heat flows into, within, and out of the present oven; and

FIG. 10 shows a variety of additional hole openings that can be employed in the present heat distribution plate.

### DETAILED DESCRIPTION OF THE INVENTION

### A. Overview

To gain a better understanding of the invention, a preferred embodiment will now be described in detail. Frequent reference will be made to the drawings. Reference numerals or letters will be used throughout to indicate certain parts or locations in the drawings. The same reference numerals or letters will be used to indicate the same parts and locations throughout the drawings, unless otherwise indicated.

### B. Environment

The preferred embodiment now described will be with respect to outdoor cooking equipment and/or grills. The scale of the embodiment, therefore, is to be understood with respect to this type of article. It is to be understood as well, however, that the invention is applicable to other articles and its scale can vary accordingly.

### C. Structure

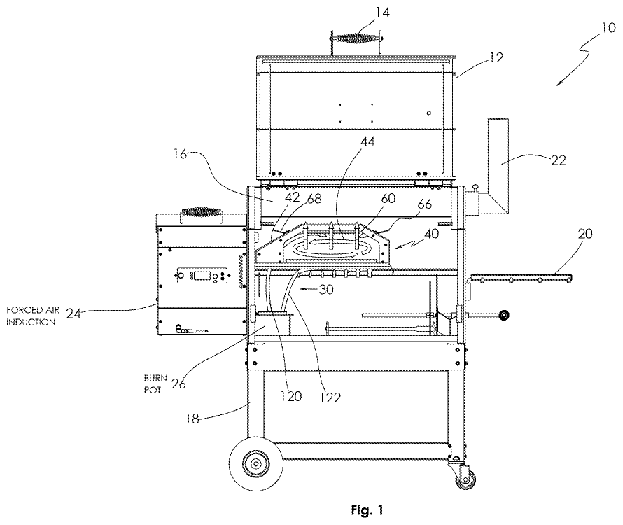

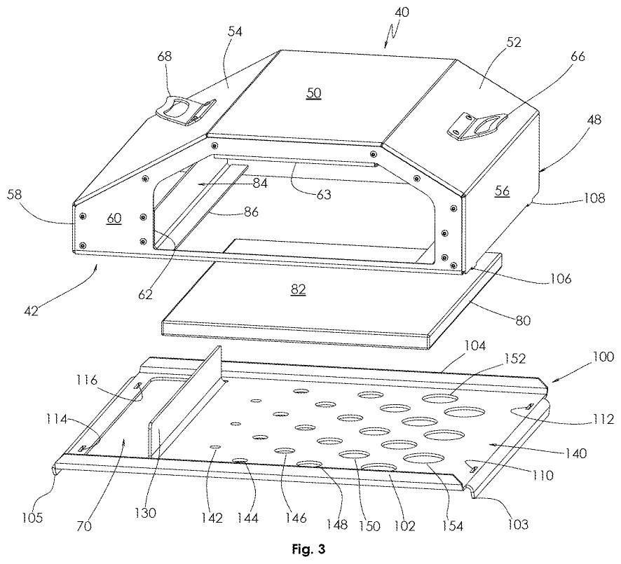

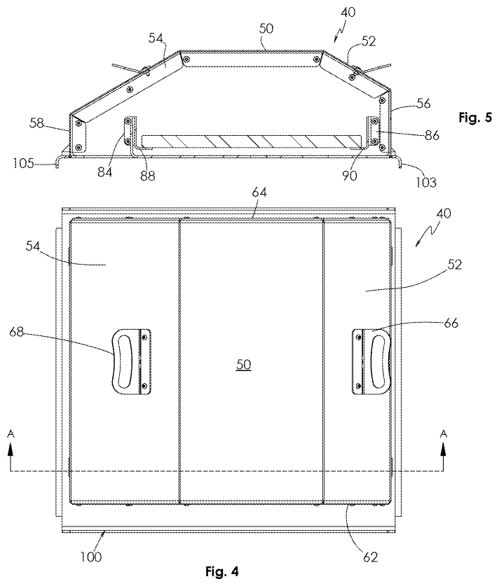

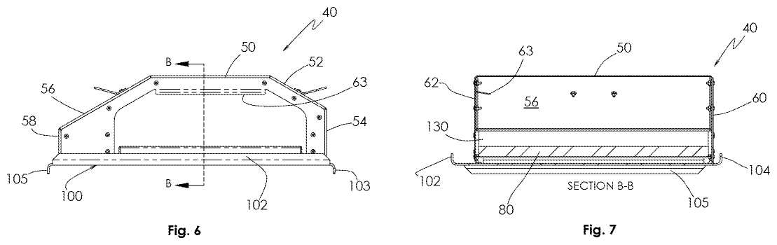

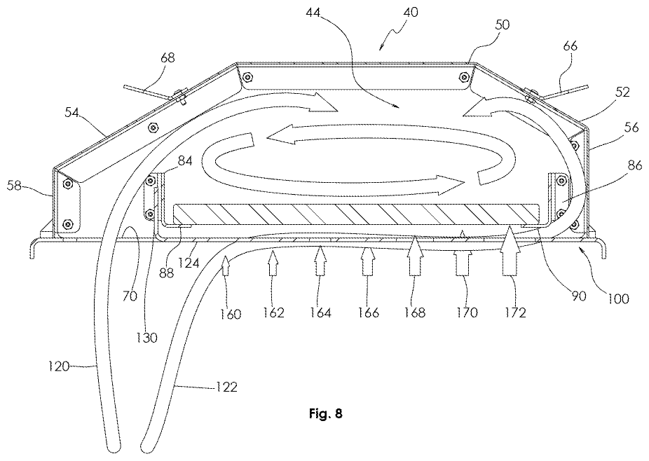

FIG. 1 shows an outdoor cooker or grill 10 having a lid, cover or main cooker door 12 that is movable between an open position, as shown here, or a closed position where the main cooking chamber 16 is enclosed. The door 12 includes a handle 14. The cooker or grill 10 includes a base 18, a shelf 20, an exhaust 22 connected to right side of the main cooking chamber 16, a fuel source 24 and a source of heat, for example, a burn pot 26. It should be understood that the heat source can be positioned on the left side or the right side of a cooker or grill, or at some other location. What is important is that there is a heat source that can produce and create a flow of heat that can be directed toward the insert oven 40. As this FIG. 1 shows there is an upwardly directed heat flow 30 emanating from the burn pot 26, or whatever heat source a given grill or cooker uses, and with the oven insert 40 positioned at the left most side of the main chamber 16. That heat flow 30 will hit the left side 42 of oven 40 and enter the interior 44 of the oven 40 through an opening such as that shown in FIG. 3 at 70 in the bottom most heat distribution plate 100. The heat flow within oven 40 will be more fully described below.

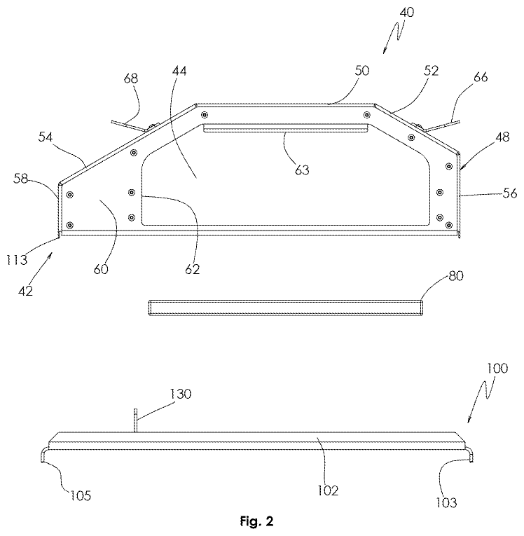

FIGS. 2 and 3 show exploded views of the oven 40, and specifically the hood structure 48 that is comprised of a flat central portion 50, two adjacent angled top walls 52 and 54 of hood 48, a right side wall 56, a left side wall 58, a front wall 60 in which there is an opening 62, and a rear wall 64. The angled top walls 52 and 54 each include a, exterior handle 66 and 68, respectively. The angle between the left side wall 58 and the top wall 56 is about 120° and the angle between side wall 54 and top wall 52 is also about 120°. These angles are also exemplary and could vary, for example, from 100° to 140°, depending on the height and length of oven 48. Oven 40 preferably is about 20 inches wide, about 18 inches deep and has a height of about 6 inches. These dimensions can vary from these preferred values. For example, the width can vary from 12 to about 36 inches, the depth can vary from 12 to about 24 inches, and the height can vary from about 4 to about 13 inches. The precise dimensions will be more a function of the size of the grill or cooker so that the foregoing dimensions are only exemplary.

The oven 40 also includes a removable cooking plate 80, that can be, for example, a cooking stone, a metal plate, heat proof synthetic materials, or cooking pans or other similar cooking devices 1 that will support what is being cooked, whether a pizza, bread, meat, fish, vegetables, or other food items. The cooking plate has an upper cooking surface 82 and is removably retained with the hood 48 by supports 84 and 86, fixed to the hood 48, and each having an inwardly facing bottom supporting flange 88 and 90, best shown in FIGS. 3 5, and 8.

The heat distribution plate 100 has an upstanding front and rear flange, 102 and 104, respectively, to better position hood 48 and its cooking plate 80, and depending end flange 103 and 105. Hood 48 is itself removably mounted on the heat distribution plate 100 100 by tabs such as those shown at 106 and 108 that can be received by openings 110 and 112, respectively. Similar positioning tabs also depend from the left side wall 50, one of which is shown at 113 in FIG. 2, that can be received by openings 114 and 116 on the left side of the heat management plate 100.

As noted previously, the heat distribution plate 100 100 has an opening 70 on the left side that will, when the oven is installed in a grill or cooker, be positioned over a source of heat, for example from burn pot 26. That incoming heat flow is depicted in FIGS. 1, 8 and 9 and as shown will have one heat flow component 120 flowing primarily vertically or upwardly toward and through opening 70 and then enter the interior 44 of oven 40. The second heat flow component 122 will be diverted by the bottom surface 124 of heat distribution plate 100 100 and will flow initially along that bottom surface 124.

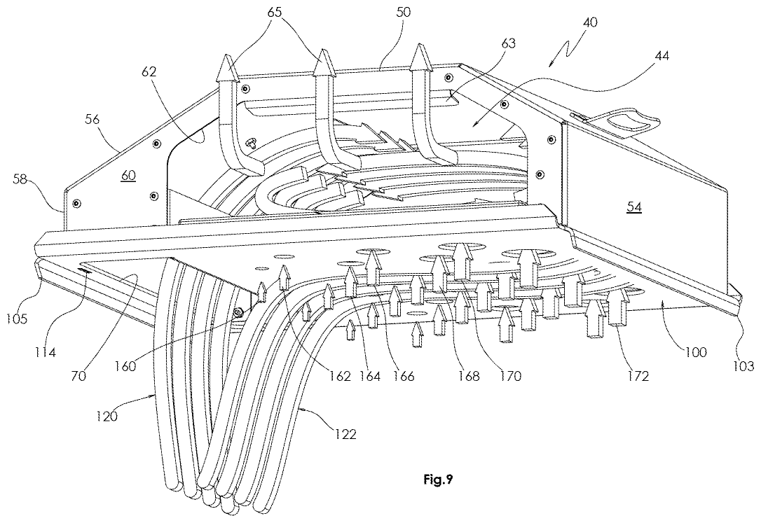

The heat distribution plate or wall 100 includes a heat deflecting wall or flange 130 that extends depth wise from the front of oven 40 to the rear wall 64 and extends vertically from the right side of opening 70. Deflecting plate 130 is preferably about 2 inches tall, but that measurement can vary from almost zero to almost touching the inside of hood 48. The positioning of deflection plat 130 is preferably at about 90° but that positioning could vary from about 60° to about 100°. This deflecting plate 130 will assist in directing the flow of the incoming heat component 120 through opening 70 to be directed upwardly toward the inner surfaces of hood 40 with the sloping top wall 54 turning the heat flow to the right as the arrow for the heat flow component 120 in FIG. 8 shows. It should be understood that the height and dimensions of the deflection plate 130 were engineered to force the heat up toward the angular top wall 54 of the hood 48. This, together with the heat flow from the opposite side of oven 48, as shown in FIGS. 8 and 9, creates a true convective style of cooking, so the bottom and top cook of what is placed on cooking plate 80 will be evenly heated, cooked and browned. This convection heating within the hood 48 also allows a pan, or another like device, to be placed on the exterior of the flat central portion 50 of hood 48 and thereby allow items to be warmed, heated, or cooked in such a pan or device.

The hood design allows intense heat, perhaps from a flame, to come up the left side of hood 48 and be directed evenly to the center of the hood 48. This hood design creates an increase in heat by as much as 50%, so a grill set at 6000 would net 9000 inside the oven attachment.

The portion 140 of the heat distribution plate 100 100, located to the right of deflecting flange 130 in FIG. 3, is instrumental in distributing heat evenly across the bottom of the cooking plate 80. In its most preferred form, and with reference to FIGS. 3, 8 and 9, the portion 140 is characterized by having a plurality of heat directing openings or holes in portion 140. Closest to deflecting flange 130 is a row, extending from the front to rear, of small holes 142 followed by successive rows holes that extend from the front to the rear and having a progressively increasing size as shown for holes 144-154 with largest 154 being positioned adjacent the right end of portion 140.

As arrows 160 172 indicate in FIGS. 8 and 9 show, heat flow through row 142 is the smallest and the heat flow thereafter increases from left to right with greatest heat flow occurring though holes 154 at the right end of the heat distribution plate 100. As both FIGS. 8 and 9 also demonstrate, the heat flowing or passing through holes 142-154 will also move from left to right beneath cooking plate 80 then upwardly along the inside of right end wall 54 and then along the inside of hood 48 and into the area above cooking plate 80. Heat flowing from the right will meet heat flowing from the left and inter-mix to swirl within the interior 44 of oven 40 over the top of cooking plate 80. The front of the oven 40 is provided with an opening 62 in the front wall 60 and heat will exhaust from the interior of oven 40 from opening 62 as shown by arrows 65 in FIG. 9. An inwardly directed lip or flange 63 is provided along the top edge of opening 62 to slow the escape of heat form the top portion of the oven 40 and will redirect some heat flow back into the oven 40. The present design for an oven insert for a grill or cooker produces an oven that will create a cooking environment to provide a cooking experience from 300° to 1200°, with pizzas cooking at a range of temperatures of about 650° to 800°, and the designed air flow and heat distribution is even and cooks and browns food being cooked evenly on both sides, as well as the tops and bottoms.

The progressive sizing of the holes 142-154 facilitates a more balanced flow of air (and subsequent heat) through them. Holes 142 closest to the heated air source 26 will experience the highest air pressure differential, those farthest from the heat source, for example holes 154, will see the lowest air pressure differential. Hence the use of small holes near the heat source and larger holes farther from the heat source will produce a better-balanced flow of heat to and around the bottom of the cooking plate 80. The goal is to evenly heat the cooking plate from side to side and front to back for the most balanced cooking, for example, complete and even cooking of the crust on a pizza from the bottom. The air passing over the top cooks the top of whatever has been placed on the cooking plate 80, such as, any pizza toppings, and has some effect on crust below the toppings.

The heat distribution plate 100 has been designed to create even heat across the cooking plate 80 from left to right, from front to back, and on the bottom as well as the top. The large opening 70 on the left side of the heat distribution plate 100 allows heat to flow upwardly from a source of heat into oven 40. The heat distribution plate 100 can, and preferably does, have a series of progressively sized holes, 142-154, provided therein, from small to large, and arranged in a direction following the heat flow as shown by arrow 122 in FIG. 8, as it moves away from the heat source 26. This combined effect of the heat flow paths created by the heat distribution plate 100 and the hood 48, working in combination, creates an even heat distribution with an offset heat source, or a heat source that is positioned adjacent one end of the oven 40. It should be understood that the oven 40 and the heat distribution plate 100 can also function with a variety of heat sources such as a pellet grill fire, for example as shown in FIG. 1, a wood fire or a gas/propane heat source. It is designed where several accessories can be set over it to create an even heat from left to right or right to left. In the case of the pizza oven, it heats the stone from the bottom evenly. It allows direct flame that can be directed to the area we design by the size, shape, height, and angle of the vertical tab on the heat distribution plate.

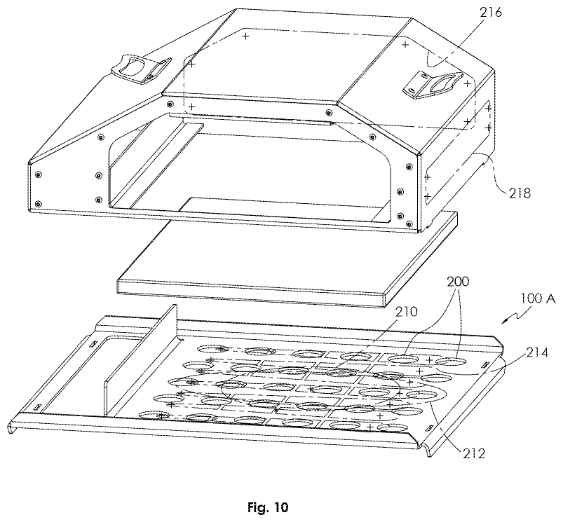

While the progressive sizing of holes 142-154 is the preferred approach, the rate of heat transfer thru the heat distribution plate 100 one could also obtain similar heating results utilizing other approaches, for example using equal size holes as is shown in FIG. 10 at 200. One could also increase the hole density as the distance from the heat source increases. Alternatively, it is possible to construct the heat distribution plate 100 with a large single hole as at 210 FIG. 10, or an oval hole 212. Additionally, one could design the heat distribution plate 100A utilizing slots 214 that have an increasing width as the distance away from the heat source increases. These slots 214 could be the full length of the plate or segmented into various lengths to maintain structural integrity of the heat distribution plate 100 100A.

When introducing elements of various aspects of the present invention or embodiments thereof, the articles “a,” “an,” “the” and “said” are intended to mean that there are one or more of the elements, unless stated otherwise. The terms “comprising,” “including” and “having,” and their derivatives, are intended to be open-ended terms that specify the presence of the stated features, elements, components, groups, and/or steps, but do not exclude the presence of other unstated features, elements, components, groups, and/or steps and mean that there may be additional features, elements, components, groups, and/or steps other than those listed. Moreover, the use of“top” and “bottom,” “front” and “rear,” “above,” and “below” and variations thereof and other terms of orientation are made for convenience but does not require any particular orientation of the components. The terms of degree such as “substantially,” “about” and “approximate,” and any derivatives, as used herein mean a reasonable amount of deviation of the modified term such that the end result is not significantly changed. For example, these terms can be construed as including a deviation of at least +/−5% of the modified term if this deviation would not negate the meaning of the word it modifies.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. A combined grill and an insert comprising
a grill having a base, a source of heat, an interior compartment, and a lid movable between open and closed positions;
a cooking insert comprised of an upper hood structure, a cooking platform, and a lower structure connected to the upper hood structure;
the upper hood structure having a top, opposing right and left side walls, a rear wall, and at least a partial front wall;
the lower structure having adjacent one end an enlarged opening, a deflection wall extending upwardly on an interior side of the opening, and a series of spaced apart openings provided at locations beginning adjacent the deflection wall and extending toward an end opposite said one end; and
the cooking platform being supported above the lower structure.

2. The combined grill and insert as in claim 1, wherein the lower structure comprises a heat distribution plate, and the series of spaced apart openings include a series of progressively enlarging holes sizes from small to large extending across at least a portion thereof.

3. The combined grill and insert as in claim 1, wherein the lower structure comprises a heat distribution plate, and the series of spaced apart openings include a group of small holes adjacent the deflection plate and a continuing series of progressively enlarging holes extending toward said opposite end.

4. The combined grill and insert as in claim 1, wherein said top comprises a first angled wall extending upwardly from the right side wall, and a second angled wall extending upwardly from said left side wall, and a top wall interconnecting the first and second angled walls.

5. The combined grill and insert as in claim 4, wherein said top wall is a flat wall.

6. The combined grill and insert as in claim 1, wherein said insert comprises an oven positioned adjacent one side of said interior compartment and said heat source provides heat to one side of said oven.

7. The combined grill and insert as in claim 6, wherein said heat source creates a flow of heat received within said one side of said oven and across a bottom surface of said lower structure.

8. The combined grill and insert as in claim 7, wherein said lower structure comprises a heat distribution plate having a heat inlet opening positioned at said one side and having a deflection plate extending upwardly along an interior side thereof, and a series of spaced apart openings including a group of small holes adjacent said deflection plate and a continuing series of progressively enlarging spaced apart holes extending toward an opposite side of said oven.

9. The combined grill and insert as in claim 7, wherein said lower structure comprises a heat distribution plate and includes a heat inlet opening positioned at said one side and having a deflection plate extending upwardly along one side thereof, and a series of spaced apart openings beginning adjacent said deflection plate and extending toward an opposite side of said oven.

10. An oven for use as an insert in a grill comprising
a hood, a cooking surface housed beneath the hood, and a heat distribution plate positioned beneath the cooking surface;
the hood having a top wall and interconnected side walls;
the heat distribution plate having a deflection plate spaced from one side thereof, a first opening on one side of the deflection plate, at least one additional opening provided in an area of heat management plate on a side opposite the deflection plate.

11. The oven as in claim 10, wherein the top wall comprising a flat central portion and angled portions extending outwardly therefrom toward each side wall.

12. The oven as in claim 10, wherein the hood has front and rear openings.

13. The oven as in claim 10, wherein an opening is provided within a right side wall.

14. The oven as in claim 10, wherein said cooking surface is removably mounted in the oven.

15. The oven as in claim 10, wherein the hood is removably mounted on the heat distribution plate.

16. The oven as in claim 10, wherein the cooking surface is comprised of stone.

17. The oven as in claim 10, wherein an area of the heat distribution plate opposite the deflection plate is provided with a plurality of openings.

18. The oven as in claim 17, wherein the plurality of openings have a common size and are spaced apart.

19. The oven as in claim 17, wherein the plurality of openings change in size progressively enlarging beginning with small openings positioned adjacent the deflection plate and extending in a spaced apart manor toward an opposite end of the heat distribution plate.

20. A heat distribution plate for use in cooking and uniformly spreading heat having a heat inlet opening positioned at one side, a deflection plate extending upwardly along an interior side thereof, and a series of spaced apart openings including a group of small holes adjacent said deflection plate and a continuing series of progressively enlarging spaced apart holes extending toward an opposite side of said oven.
